(19) United States
(12) Patent Application Publication
(10) Pub. No.: US 2020/0123295 A1
(43) Pub. Date: Apr. 23, 2020

(54) METHACRYLIC COPOLYMER AND SOLUTION CONTAINING SAME

(71) Applicant: KURARAY CO., LTD., Kurashiki-sbi (JP)

(72) Inventors: Toru TAKAHASHI, Tsukuba-shi (JP); Tatsuya OKADA, Chiyoda-ku (JP); Ryotaro KURIBAYASHI, Chiyoda-ku (JP)

(73) Assignee: KURARAY CO., LTD., Kurashiki-shi (JP)

(21) Appl. No.: 16/626,032

(22) PCT Filed: Jun. 26, 2018
(86) PCT No.: PCT/JP2018/024105

§ 371 Date: Dec. 23, 2019

(30) Foreign Application Priority Data
Jun. 30, 2017 (JP) 2017-128612
Nov. 29, 2017 (JP) 2017-228539

(51) Int. Cl. C08F 220/68; C08F 220/14; C09D 7/20; C09D 133/08; C09D 133/12; C09D 11/107; C09D 11/033; C10M 169/04; C10M 101/00; C10M 107/02; C10M 145/14

(52) U.S. Cl. CPC C08F 220/68; C10N 2240/08; C09D 7/20; C09D 133/08; C09D 133/12; C09D 11/107; C09D 11/033; C10M 169/041; C10M 101/00; C10M 107/02; C10M 145/14; C10M 2203/003; C10M 2205/0206; C10M 2209/084; C10N 2240/104; C10N 2240/102; C10N 2240/044; C10N 2240/042; C10N 2240/045; C10N 2240/046; C08F 220/14

(57) ABSTRACT

This invention provides A methacrylic copolymer (C) comprising 25 to 35 mass % of a methyl methacrylate unit (A), and 75 to 65 mass % of an alkyl methacrylate ester unit (B) containing an alkyl group having 10 to 36 carbon atoms, the methacrylic copolymer having (a) a weight average molecular weight of 10,000 to 500,000, (b) a molecular weight distribution (Mw/Mn) of 1.01 to 1.60, (c) a triad syndiotacticity (rr) of 65% or more, and (d) a solubility of 5.0 mass % or more at 0° C. in at least one lubricant base oil (D) selected from the group consisting of API groups III, III+, and IV.

### TECHNICAL FIELD

The present invention relates to a methacrylic copolymer and to a solution, a lubricating oil composition, and a viscosity index improver, each containing the methacrylic copolymer.

### BACKGROUND ART

In recent years, for protection of the global environment, achieving energy savings with lubricating oil and extending the service life of lubricating oil are important problems. To solve these problems, it is essential to improve the performance of lubricating oil, such as the viscosity index and shear stability.

Hitherto known viscosity index improvers for adding to a lubricant base oil include a narrow-dispersion (meth)acrylic polymer having a small molecular weight distribution (Mw/Mn), which is a ratio of a weight average molecular weight (Mw) to a number average molecular weight (Mn) (see Patent Literature (PTL) 1, PTL 2, PTL 3, and PTL 4), and a (meth)acrylic copolymer with a high triad syndiotacticity (PTL 5).

PTL 1 and PTL 2 disclose a lubricating oil composition containing a narrow-dispersion (meth)acrylic copolymer with a low Mw/Mn, obtained by anionic polymerization. PTL 3 discloses a lubricating oil composition containing a narrow-dispersion (meth)acryl copolymer with a low Mw/Mn, obtained by atom transfer radical polymerization (ATRP). However, PTL 1, PTL 2, and PTL 3 nowhere specifically disclose their performance as a viscosity index improver.

PTL 4 discloses an example in which a narrow-dispersion (meth)acrylic copolymer with a low Mw/Mn obtained by reversible-addition fragmentation-chain transfer (RAFT) polymerization is used as a viscosity index improver; however, its shear stability is insufficient.

PTL 5 discloses a viscosity index improver comprising a (meth)acrylic copolymer obtained by polymerization using a catalyst system comprising an organic aluminum compound, phenols, and a bisoxazoline compound, and having a triad syndiotacticity (rr) of 88 to 95%; however, PTL 5 is silent about the effect of shear stability.

### CITATION LIST

### Patent Literature

### PTL 1: JPH11-286520A

### PTL 2: JPH11-302333A

### PTL 3: JP2003-515630A

### PTL 4: JP 2008-518051A

### PTL 5: JP 2009-074068A

### SUMMARY OF INVENTION

### Technical Problem

An object of the present invention is to provide a methacrylic copolymer that has a narrow molecular weight distribution and that is soluble in a specific lubricant base oil.

Another object of the present invention is to provide a methacrylic copolymer having an excellent ability to improve viscosity index and an excellent shear stability when used, for example, as a viscosity index improver.

### Solution to Problem

In order to achieve the above objects, the present inventors conducted extensive research. The present inventors have thus completed the invention encompassing the following embodiments.

[1]

A methacrylic copolymer (C) comprising:

25 to 35 mass % of a methyl methacrylate unit (A); and
75 to 65 mass % of an alkyl methacrylate ester unit (B) containing an alkyl group having 10 to 36 carbon atoms,
the methacrylic copolymer having
(a) a weight average molecular weight of 10,000 to 500,000,
(b) a molecular weight distribution (Mw/Mn) of 1.01 to 1.60,
(c) a triad syndiotacticity (rr) of 65% or more, and
(d) a solubility of 5.0 mass % or more at 0° C. in at least one lubricant base oil (D) selected from the group consisting of API groups III, III+, and IV.
[2]

The methacrylic copolymer according to [1], wherein the methyl methacrylate unit (A) is present in an amount of 30 to 35 mass %.

[3]

The methacrylic copolymer according to [1] or [2], which has a weight average molecular weight of 20,000 to 450,000.

[4]

The methacrylic copolymer according to any one of [1] to [3], comprising a combination of an alkyl methacrylate ester unit (B1) containing an alkyl group having 14 to 30 carbon atoms and an alkyl methacrylate ester unit (B2) containing an alkyl group having 10 to 13 carbon atoms, as the alkyl methacrylate ester unit (B) containing an alkyl group having 10 to 36 carbon atoms, and having a mass ratio of the alkyl methacrylate ester unit (B1)/the alkyl methacrylate ester unit (B2) of 10/90 to 90/10.

[5]

The methacrylic copolymer according to any one of [1]to [4], which has a molecular weight distribution (Mw/Mn) of 1.01 to 1.40.

[6]

A method for producing the methacrylic copolymer of any one of [1] to [5], comprising

anionically polymerizing a monomer mixture comprising methyl methacrylate and an alkyl methacrylate ester containing an alkyl group having 10 to 36 carbon atoms in the presence of an organic aluminum compound.

[7]

A methacrylic copolymer solution containing the methacrylic copolymer of any one of [1] to [5] and an organic solvent.

[8]

The methacrylic copolymer solution according to [7], wherein the organic solvent is at least one lubricant base oil selected from the group consisting of API groups III, III+, and IV.

[9]

The methacrylic copolymer solution according to [7], wherein the organic solvent is an organic solvent for paint.

[10]

The methacrylic copolymer solution according to [7], wherein the organic solvent is an organic solvent for ink.

[11]

A lubricating oil composition comprising the methacrylic copolymer of any one of [1] to [5] and at least one lubricant base oil (D) selected from the group consisting of API groups III, III+, and IV.

[12]

The lubricating oil composition according to [11], wherein the methacrylic copolymer is present in an amount of 10 to 50 mass %.

[13]

The lubricating oil composition according to [11] or [12], wherein the lubricant base oil (D) is a mineral oil or poly-α-olefin synthetic oil.

[14]

A viscosity index improver containing the methacrylic copolymer of any one of [1] to [5].

### Advantageous Effects of Invention

According to the present invention, obtaining a methacrylic copolymer that has a narrow molecular weight distribution and that is soluble in a specific lubricant base oil is possible, and thus achieving a high viscosity index of lubricating oil is possible.

Moreover, according to the present invention, providing a methacrylic copolymer having an excellent ability to improve viscosity index and an excellent shear stability when used, for example, as a viscosity index improver is possible.

### DESCRIPTION OF EMBODIMENTS

The methacrylic copolymer of the present invention comprises:

25 to 35 mass % of a methyl methacrylate unit (A); and
75 to 65 mass % of an alkyl methacrylate ester unit (B) containing an alkyl group having 10 to 36 carbon atoms,
the methacrylic copolymer having
(a) a weight average molecular weight of 10,000 to 500,000,
(b) a molecular weight distribution (Mw/Mn) of 1.01 to 1.60,
(c) a triad syndiotacticity (rr) of 65% or more, and
(d) a solubility of 5.0 mass % or more at 0° C. in at least one lubricant base oil (D) selected from the group consisting of API groups III, III+, and IV.

The present invention is described in more detail below.

The amount of the methyl methacrylate unit (A) present in the methacrylic copolymer of the present invention is 25 to 35 mass %, and preferably 30 to 35 mass %. When the amount of the methyl methacrylate unit (A) is within this range, excellent solubility in a lubricant base oil, which is important when used as a viscosity index improver, is obtained, ensuring an excellent ability to improve the viscosity index.

The amount of the alkyl methacrylate ester unit (B) present in the methacrylic copolymer of the present invention is 65 to 75 mass %, and preferably 65 to 70 mass %. When the amount of the alkyl methacrylate ester unit (B) is within this range, excellent solubility in a lubricant base oil, as well as an excellent ability to improve viscosity index, are obtained.

Examples of the alkyl methacrylate ester unit (B) containing an alkyl group having 10 to 36 carbon atoms in the methacrylic copolymer of the present invention include alkyl methacrylate esters containing a straight-chain alkyl group having 10 to 36 carbon atoms, such as N-decyl methacrylate, n-undecyl methacrylate, N-dodecyl methacrylate (trivial name: lauryl methacrylate), n-tridecyl methacrylate, n-tetradecyl methacrylate, n-pentadecyl methacrylate, n-hexadecyl methacrylate, n-heptadecyl methacrylate, n-octadecyl methacrylate (trivial name: stearyl methacrylate), n-nonadecyl methacrylate, n-eicosyl methacrylate, n-henicosyl methacrylate, n-docosyl methacrylate, n-tricosyl methacrylate, n-tetracosyl methacrylate, n-pentacosyl methacrylate, n-hexacosyl methacrylate, n-heptacosyl methacrylate, n-octacosyl methacrylate, n-nonacosyl methacrylate, n-triacontyl methacrylate, n-hentriacontyl methacrylate, n-dotriacontyl methacrylate, n-tritriacontyl methacrylate, n-tetratriacontyl methacrylate, n-pentatriacontyl methacrylate, and n-hexatriacontyl methacrylate; alkyl methacrylate esters containing a branched-chain alkyl group having 10 to 36 carbon atoms, such as isodecyl methacrylate, 2,4,6-trimethylheptyl methacrylate, 2-butyloctyl methacrylate, 2-ethyl-n-dodecyl methacrylate, 2-methyl-n-tetradecyl methacrylate, isohexadecyl methacrylate, 2-n-octyl-n-nonyl methacrylate, isooctadecyl methacrylate, 1-n-hexyl-n-tridecyl methacrylate, 2-ethyl-n-heptadecyl methacrylate, isoicosyl methacrylate (another name: 2-n-octyl-n-dodecyl methacrylate), 1-n-octyl-n-pentadecyl methacrylate, 2-n-decyl-n-tetradecyl methacrylate, 2-n-dodecyl-n-pentadecyl methacrylate, isotriacontyl methacrylate, 2-n-tetradecyl-n-heptadecyl methacrylate, 2-n-hexadecyl-n-heptadecyl methacrylate, 2-n-hexadecyl-n-icosyl methacrylate, and 2-n-tetradecyl-n-docosyl methacrylate; and the like.

From the viewpoint of solubility in a lubricant base oil, the alkyl methacrylate ester unit (B) containing an alkyl group having 10 to 36 carbon atoms is more preferably an alkyl methacrylate ester unit containing an alkyl group having 14 to 30 carbon atoms, still more preferably an alkyl methacrylate ester unit containing an alkyl group having 16 to 28 carbon atoms, and particularly preferably an alkyl methacrylate ester unit containing an alkyl group having 16 to 24 carbon atoms. For the methacrylic copolymer of the present invention, the alkyl methacrylate ester units containing an alkyl group having 10 to 36 carbon atoms may be used singly or in a combination of two or more. To use these units in a combination of two or more, an alkyl methacrylate ester unit (B1) containing an alkyl group having 14 to 30 carbon atoms and an alkyl methacrylate ester unit (B2) containing an alkyl group having 10 to 13 carbon atoms may be used in combination. The mass ratio of the alkyl methacrylate ester unit (B1)/the alkyl methacrylate ester unit (B2) is preferably 10/90 to 90/10, and more preferably 40/60 to 49/51, to prevent the alkyl from being crystallized and to improve solubility at low temperatures.

The methacrylic copolymer (C) preferably has a solubility of 5.0 mass % or more in a lubricant base oil that is of API group III or higher (III, III+, or IV) and that has a viscosity index of 120 or more. The expression “having a solubility of 5.0 mass % or more” as used herein means that when 5 parts by mass of the methacrylic copolymer (C) is added to 95 parts by mass of a lubricant base oil (D), no undissolved residue of the methacrylic copolymer (C) remains, and the appearance is uniform at a temperature of 0 to 80° C.

From among the base oils categorized into the API standards of the American Petroleum Institute (API groups I to V), the lubricant base oil (D) used in the present invention is of API group III or higher.

API group I: 0.03% or more sulfur content and/or less than 90% saturates content, viscosity index: 80 to 120 (mineral oil);
API group II: 0.03% or less sulfur content and 90% or more saturates content, viscosity index: 80 to 120 (hydrocracked oil);
API group III: 0.03 or less sulfur content and 90% or more saturates content, viscosity index: 120 or more (VHVI);
API group III+: 0.03% or less sulfur content and 90% or more saturates content, viscosity index: 135 or more (VHVI);
API group IV: poly-α-olefin (chemical synthesis oil); and
API group V: those that do not belong to API groups I to IV (vegetable oils, esters, alkyl naphthalenes, and PAGs).

The lubricant base oil (D) comprises at least one member selected from the group consisting of API group III, API group III+, API group IV, and API group V base oils. The lubricant base oil (D) is preferably an API group III, API group III+, or API group IV oil, more preferably an API group III or API group III+ oil, and still more preferably an API group III oil.

Examples of the products of the lubricant base oils (D) of API groups III to V include the following:

API group III: YUBASE 2, 3, 4, 6, and 8, and PHAZOL 7 and 35 (all are produced by Exxon Mobil Corporation);
API group III+: YUBASE 4 and 6 plus (all are produced by Exxon Mobil Corporation); and
API group IV: SpectraSyn, SpectraSynPlus, SpectraSynUltra (all are produced by Exxon Mobil Corporation).

Additionally, Diana Fresia series (produced by Idemitsu Kosan Co., Ltd.), ultra-S series (produced by S-OIL Corporation), and the like may also be used.

The methacrylic copolymer of the present invention has a triad syndiotacticity (rr) of 65 to 100%, preferably 70 to 100%, more preferably 75 to 100%, and still more preferably 75 to 85%. Polymer chains having a high triad syndiotacticity (rr) are generally rigid, and thus can maintain a high solution viscosity even at high temperatures, achieving an excellent effect of improving the viscosity index. When polymerization is performed at a lower temperature, a higher syndiotacticity is obtained. The polymerization temperature is preferably 50° C. or lower, more preferably 30° C. or lower, and still more preferably 20° C. or lower.

The triad syndiotacticity (rr) as used herein (hereinafter sometimes simply referred to as “the syndiotacticity (rr)”) is a percentage of chains of two units (diads) being both racemo diads (expressed as “rr”) in chains of successive three structural units (triads). In polymer molecules, a chain of structural units (diads) that have the same stereo configuration is called meso while a chain of structural units (diads) that are oriented in opposition to each other is called racemo, which are referred to as m and r, respectively.

The methacrylic copolymer of the present invention is soluble in a lubricant base oil. In this specification, the expression of being “soluble in a lubricant base oil” means that a 5.0 mass % solution obtained by adding 5 parts by mass of the methacrylic copolymer to 95 parts by mass of a lubricant base oil selected from mineral oils (API groups I to III+), poly-α-olefin (API group IV) synthetic oils, and ester oils (API group V) contains no undissolved residue of the methacrylic copolymer at 0° C., and the appearance thereof is uniform at a temperature of 0 to 80° C. The specific procedure is in accordance with the method disclosed in the Examples below. The solubility in a lubricant base oil can be adjusted by the amount of the methyl methacrylate unit (A) in the methacrylic copolymer, and the type of the alkyl methacrylate ester unit (B) to be selected.

The methacrylic copolymer (C) may further comprise one or more other (meth)acrylic acid ester monomer-derived units, in addition to the above alkyl methacrylate esters. Examples of the other (meth)acrylic acid ester monomer units include units of (meth)acrylic acid esters containing alicyclic alkyl, such as cyclopentyl (meth)acrylate, cyclohexyl (meth)acrylate, isobornyl (meth)acrylate, and tricyclododecyl (meth)acrylate;

(meth)acrylic acid esters containing aromatic hydrocarbon, such as phenyl (meth)acrylate, benzyl (meth)acrylate, naphthyl (meth)acrylate, and biphenyl (meth)acrylate;
(meth)acrylic acid esters containing ether, such as methoxymethyl (meth)acrylate, 2-methoxyethyl (meth)acrylate, 2-methoxypropyl (meth)acrylate, 2-ethoxyethyl (meth)acrylate, 2-ethoxypropyl (meth)acrylate, methoxy polyethylene glycol (meth)acrylate, and methoxy polypropylene glycol (meth)acrylate;
N,N-dialkyl (meth)acrylamide, such as N,N-dimethyl (meth)acrylamide, N,N-diethyl (meth)acrylamide, N,N-diisopropyl (meth)acrylamide, and N,N-di-n-butyl (meth)acrylamide; (meth)acrylic acid esters containing epoxy, such as glycidyl (meth)acrylate;
multifunctional (meth)acrylic acid esters, such as 1,3-propanediol di(meth)acrylate, 1,3-butanediol di(meth)acrylate, 1,4-butanediol di(meth)acrylate, 1,6-hexanediol di(meth)acrylate, 1,9-nonanediol di(meth)acrylate, 1,10-decanediol di(meth)acrylate, neopentylglycol di(meth)acrylate, polyalkyleneglycol di(meth)acrylate, bisphenol A di(meth)acrylate, tricyclodecanedimethanol di(meth)acrylate, trimethylolpropane tri(meth)acrylate, glycerol tri(meth)acrylate, and pentaerythritol tetra(meth)acrylate;
alkyl (meth)acrylate esters containing a straight- or branched-chain alkyl group having 2 to 9 carbon atoms;
methyl acrylate; and the like;
alkyl acrylate ester units corresponding to the alkyl methacrylate ester unit (B); and the like.

The methacrylic copolymer of the present invention has a weight average molecular weight (Mw) of 10,000 to 500,000. In a preferable embodiment, the lower limit of the weight average molecular weight (Mw) is preferably 20,000 or more, more preferably 100,000 or more, still more preferably 150,000 or more, and particularly preferably 200,000 or more. The upper limit is preferably 450,000 or less, more preferably 400,000 or less, and still more preferably 370,000 or less.

In a preferable embodiment, the upper limit of the number average molecular weight (Mn) of the methacrylic copolymer (C) is preferably 6,300 or more, more preferably 13,000 or more, still more preferably 62,000 or more, and particularly preferably 125,000 or more. The upper limit is preferably 490,000 or less, more preferably 390,000 or less, and still more preferably 360,000 or less.

When the weight average molecular weight (Mw) and number average molecular weight (Mn) fall within the above ranges, an excellent ability to improve the viscosity index and an excellent shear stability are obtained.

The methacrylic copolymer of the present invention has a molecular weight distribution (Mw/Mn) of 1.01 to 1.60. In one preferable embodiment, the molecular weight distribution is preferably 1.01 to 1.50, and more preferably 1.01 to 1.40. In another preferable embodiment, the molecular weight distribution is preferably 1.01 to 1.4, more preferably 1.02 to 1.4, still more preferably 1.05 to 1.4, and particularly preferably 1.05 to 1.3. When the molecular weight distribution (Mw/Mn) falls within the above range, an excellent ability to improve the viscosity index and an excellent shear stability are obtained. The Mw and Mn depend on, for example, the amounts of a hydroxy-containing compound in the starting material comprising alkyl methacrylate ester monomers used in the production of the methacrylic copolymer, and a polymerization inhibitor. The Mw and Mn are polystyrene-equivalent molecular weight values obtained by GPC measurement.

The method for producing the methacrylic copolymer of the present invention is preferably atom transfer radical polymerization (ATRP), reversible addition-fragmentation chain-transfer (RAFT) polymerization, nitroxide-mediated polymerization (NMP), iodine transfer polymerization, polymerization with higher periodic heteroatoms (such as organic tellurium, antimony, and bismuth), boron-mediated polymerization, catalytic chain transfer (CCT) polymerization, controlled radical polymerization, such as polymerization using metals such as cobalt and titanium and carbon bonds as dormant species (OMRP), or anionic polymerization (typically, highly living anionic polymerization). Further, anionic polymerization is more preferable because a methacrylic copolymer with high thermal stability is obtained. Examples of such anionic polymerization methods include anionic polymerization using an organoalkali metal compound as a polymerization initiator in the presence of a mineral acid salt such as an alkali metal or alkaline earth metal salt (see JPH07-25859B); anionic polymerization using an organoalkali metal compound as a polymerization initiator in the presence of an organoaluminum compound (see JPH11-335432A); anionic polymerization using an organic rare earth metal complex or a metallocene metal complex as a polymerization initiator (see JPH06-93060A); and the like. It is particularly preferable to use anionic polymerization using an organoalkali metal compound as a polymerization initiator in the presence of an organoaluminum compound to obtain a polymer having a smaller Mw/Mn to achieve a stable shear viscosity when used as a viscosity index improver, as well as to obtain a polymer having a high syndiotacticity to exhibit a high ability to improve the viscosity index when used as a viscosity index improver.

The methacrylic copolymer (C) is preferably produced by anionic polymerization using an organoalkali metal compound as a polymerization initiator in the presence of an organoaluminum compound. For example, this preferred method is performed by polymerizing the (meth)acrylic acid ester in the presence of an organolithium compound as the organoalkali metal compound, and an organoaluminum compound represented by the following general formula (1):

AlR¹R²—R³ (1)

(wherein R¹, R², and R³ are each independently an optionally substituted alkyl group, an optionally substituted cycloalkyl group, an optionally substituted aryl group, an optionally substituted aralkyl group, an optionally substituted alkoxyl group, an optionally substituted aryloxy group or an N,N-disubstituted amino group, or wherein R¹ represents any of the above groups, and R² and R³ together represent an optionally substituted arylenedioxy group), and,
optionally further in the presence of an ether, such as dimethyl ether, dimethoxyethane, diethoxyethane, or 12-crown-4; and/or a nitrogen-containing compound, such as triethylamine, N,N,N′,N′-tetramethylethylenediamine, N,N,N′,N″,N″-pentamethyldiethylenetriamine, 1,1,4,7,10,10-hexamethyltriethylenetetramine, pyridine, or 2,2′-dipyridyl in the reaction system.

Examples of the organolithium compound used in the anionic polymerization method include alkyllithiums and alkyldilithiums, such as methyllithium, ethyllithium, n-propyllithium, isopropyllithium, n-butyllithium, sec-butyllithium, isobutyllithium, tert-butyllithium, n-pentyllithium, n-hexyllithium, tetramethylenedilithium, pentamethylenedilithium, and hexamethylenedilithium; aryllithiums and aryldilithiums, such as phenyllithium, m-tolyllithium, p-tolyllithium, xylyllithium, and lithium naphthalene; aralkyllithiums and aralkyldilithiums, such as benzyllithium, diphenylmethyllithium, trityllithium, 1,1-diphenyl-3-methylpentyllithium, α-methylstyryllithium and dilithium formed by the reaction of diisopropenylbenzene and butyllithium; lithium amides, such as lithium dimethylamide, lithium diethylamide, and lithium diisopropylamide; and lithium alkoxides, such as methoxylithium, ethoxylithium, n-propoxylithium, isopropoxylithium, n-butoxylithium, sec-butoxylithium, tert-butoxylithium, pentyloxylithium, hexyloxylithium, heptyloxylithium, octyloxylithium, phenoxylithium, 4-methylphenoxylithium, benzyloxylithium, and 4-methylbenzyloxylithium. These may be used alone or in a combination of two or more.

Examples of the organoaluminum compound of the general formula (1) include trialkylaluminums, such as trimethylaluminum, triethylaluminum, triisobutylaluminum, and tri-n-octylaluminum; dialkylphenoxyaluminums, such as dimethyl(2,6-di-tert-butyl-4-methylphenoxy)aluminum, dimethyl(2,6-di-tert-butylphenoxy)aluminum, diethyl(2,6-di-tert-butyl-4-methylphenoxy)aluminum, diethyl(2,6-di-tert-butylphenoxy)aluminum, diisobutyl(2,6-di-tert-butyl-4-methylphenoxy)aluminum, and diisobutyl(2,6-di-tert-butylphenoxy)aluminum; alkyldiphenoxyaluminums, such as methylbis(2,6-di-tert-butyl-4-methylphenoxy)aluminum, methylbis(2,6-di-tert-butylphenoxy)aluminum, ethyl[2,2′-methylenebis(4-methyl-6-tert-butylphenoxy)]aluminum, ethylbis(2,6-di-tert-butyl-4-methylphenoxy)aluminum, ethylbis(2,6-di-tert-butylphenoxy)aluminum, ethyl[2,2′-methylenebis(4-methyl-6-tert-butylphenoxy)]aluminum, isobutylbis(2,6-di-tert-butyl-4-methylphenoxy)aluminum, isobutylbis(2,6-di-tert-butylphenoxy)aluminum, and isobutyl[2,2′-methylenebis(4-methyl-6-tert-butylphenoxy)]aluminum; alkoxydiphenoxyaluminums, such as methoxybis(2,6-di-tert-butyl-4-methylphenoxy)aluminum, methoxybis(2,6-di-tert-butylphenoxy)aluminum, methoxy[2,2′-methylenebis(4-methyl-6-tert-butylphenoxy)]aluminum, ethoxybis(2,6-di-tert-butyl-4-methylphenoxy)aluminum, ethoxybis(2,6-di-tert-butylphenoxy)aluminum, ethoxy[2,2′-methylenebis(4-methyl-6-tert-butylphenoxy)]aluminum, isopropoxybis(2,6-di-tert-butyl-4-methylphenoxy)aluminum, isopropoxybis(2,6-di-tert-butylphenoxy)aluminum, and isopropoxy[2,2′-methylenebis(4-methyl-6-tert-butylphenoxy)]aluminum; and triphenoxyaluminums, such as tris(2,6-di-tert-butyl-4-methylphenoxy)aluminum and tris(2,6-diphenylphenoxy)aluminum. These may be used alone or in a combination of two or more. Of these, isobutylbis(2,6-di-tert-butyl-4-methylphenoxy)aluminum, isobutylbis(2,6-di-tert-butylphenoxy)aluminum and isobutyl[2,2′-methylenebis(4-methyl-6-tert-butylphenoxy)]aluminum are particularly preferable for use because they are easy to handle and can allow polymerization of the (meth)acrylic acid ester to proceed under relatively mild temperature conditions without being deactivated.

The methacrylic copolymer (C) may be a random copolymer, a block copolymer, a graft copolymer, or a star-shaped copolymer, and is preferably a random copolymer.

For example, the methacrylic copolymer of the present invention can be obtained by terminating the polymerization reaction by the addition of a polymerization terminator to the reaction solution after polymerization. Examples of the polymerization terminator for anionic polymerization include water, methanol, acetic acid, hydrochloric acid, and other protic compounds. The amount of the polymerization terminator used is not particularly limited, and is usually 1 to 100 molar times the amount of the polymerization initiator used.

If aluminum originating from the organoaluminum compound remains in the solution of the methacrylic copolymer (C) after the termination of anionic polymerization, properties of the methacrylic copolymer (C) or a material obtained by using the copolymer may be deteriorated. It is therefore preferable to remove aluminum originating from the organoaluminum compound after the completion of the polymerization. Examples of effective methods for removing aluminum include a method in which the polymerization reaction liquid obtained after the addition of the polymerization terminator is washed with an acidic aqueous solution; a method in which the polymerization reaction liquid is subjected to treatment such as adsorption treatment using an adsorbent, such as an ion exchange resin; a method of separation by precipitation; and the like.

Examples of the organic solvent used in the present invention include aliphatic-based solvents, such as n-pentane, n-hexane, n-heptane, n-decane, cyclohexane, methylcyclohexane, ethylcyclohexane, and mineral oil; aromatic solvents, such as benzene, toluene, xylene, and ethylbenzene; ester solvents, such as ethyl acetate, n-propyl acetate, isopropyl acetate, n-butyl acetate, isobutyl acetate, and sec-butyl acetate; ketone solvents, such as acetone, methyl ethyl ketone, methyl isobutyl ketone, diisobutyl ketone, and cyclohexanone; glycol ether solvents, such as ethylene glycol monomethyl ether, diethylene glycol monomethyl ether, triethylene glycol monomethyl ether, propylene glycol monomethyl ether, and 3-methoxy-3-methyl-1-butanol; glycol ether ester solvents, such as ethylene glycol monomethyl ether acetate, PMA (propylene glycol monomethyl ether acetate), diethylene glycol monobutyl ether acetate, and diethylene glycol monoethyl ether acetate; and the like. These organic solvents may be used alone or in a combination of two or more. These organic solvents are preferably used as an organic solvent for paint or for ink.

The amount of the methacrylic copolymer of the present invention in the total mass of the methacrylic copolymer solution of the present invention used for paint or ink is preferably 0.1 to 10.0 mass %, and more preferably 0.5 to 5.0 mass %.

The solution obtained by using the above organic solvent for dissolution exhibits thixotropy. In the present invention, the degree of thixotropy is represented by a TI value. The TI value refers to a thixotropic index, which is calculated by measuring the viscosity using a rotational viscometer, such as an E-type viscometer, by changing the number of rotations, and dividing the numerical value at a low-speed rotation by the numerical value at a high-speed rotation. More specifically, this value is calculated by 6 rpm/60 rpm. When this value is greater than 1, thixotropy is considered to be exhibited.

As stated above, the TI value is calculated by the following formula using an E-type rotational viscometer (produced by Toki Sangyo Co., Ltd., a rotational viscometer TVE-25L).

TI value=viscosity at 6 rpm/viscosity at 60 rpm
Rotor No. R01, measurement temperature: 25° C.

The methacrylic copolymer of the present invention is suitably used as a viscosity index improver by mixing with, for example, a lubricant base oil meeting the API standards. For the viscosity index improver of the present invention, any oil can be used without particular limitation as long as it is a lubricant base oil meeting the API standards. The oil is preferably a mineral oil or a poly-α-olefin synthetic oil, and more preferably a mineral oil. Examples of the mineral oil include YUBASE 4 (API group III, viscosity index: 122), YUBASE 4+(API group III+, viscosity index: 136), YUBASE 6 (API group III, viscosity index: 131), YUBASE 6+(API group III+, viscosity index: 145), and YUBASE 8 (API group III, viscosity index: 128), produced by SK lubricants Co., Ltd.; and other commercially available mineral oils. Examples of the synthetic oil include SpectraSyn 4 (API group IV, viscosity index: 126), SpectraSyn 5 (API group IV, viscosity index: 138), SpectraSyn 6 (API group IV, viscosity index: 138), SpectraSyn 8 (API group IV, viscosity index: 139), SpectraSyn 10 (API group IV, viscosity index: 147), and SpectraSyn 100 (API group IV, viscosity index: 170), produced by Exxon Mobil Corporation; and other commercially available synthetic oils.

In a solution obtained by dissolving the methacrylic copolymer (C) of the present invention in a lubricant base oil (D) (mass ratio: 5:95), no remaining insoluble residue is present after being allowed to stand at 0° C. for 24 hours. The mass of the methacrylic copolymer (C) in the methacrylic copolymer solution obtained by dissolving the methacrylic copolymer (C) in the lubricant base oil (D) is preferably 10 mass % or more and 50 mass % or less, and more preferably 15 mass % or more and 25 mass % or less, from the viewpoint of the handleability of the resulting lubricant base oil solution.

The lubricant base oil solution containing the methacrylic copolymer of the present invention (C) may further contain other additives. Examples of the additives include other viscosity index improvers, antioxidants, dispersion agents, antioxidants, thermal deterioration inhibitors, light stabilizers, UV absorbers, lubricants, release agents, polymeric processing aids, antistatic agents, flame retardants, dyes and pigments, light diffusing agents, organic dyes, matting agents, impact modifiers, fluorescent materials, extreme pressure agents, oiliness improvers, friction and wear modifiers, corrosion inhibitors, cleaners, rust inhibitors, pour point depressants, demulsifiers, metal deactivators, antifoaming agents, ashless friction modifiers, and the like.

The methacrylic copolymer of the present invention exhibits a narrow molecular weight distribution and excellent mechanical characteristics, such as shear stability. Therefore, the methacrylic copolymer of the present invention can be used in various applications, including not only viscosity index improvers for lubricating oils but also polyolefin modifiers, pressure-sensitive adhesives, adhesives, primers, surface-functionalization coating agents such as hard coats, tire modifiers, and viscosity modifiers for paint or ink.

The lubricating oil composition comprising the viscosity index improver of the present invention is suitably used for engine oils (e.g., for gasoline, for diesel), drive system oils (gear oils (e.g., manual transmission oil, differential oil), automatic transmission oils (ATF (automatic transmission fluid), CVTF (continuously variable transmission fluid))), hydraulic oils (power-steering oil, shock absorber oil), and the like. Of these, preferred are engine oils, drive system oils, and hydraulic oils, and particularly preferred are engine oils.

The amount of the methacrylic copolymer of the present invention contained in the lubricating oil composition comprising the viscosity index improver of the present invention is preferably 0.1 to 30 mass %, more preferably 0.5 to 20 mass %, and still more preferably 1 to 10 mass %, based on the total mass of the lubricating oil composition. When the amount is within the above range, a particularly excellent ability to improve viscosity index and excellent shear stability are exerted.

### EXAMPLES

The present invention is described in more detail below with reference to Examples and Comparative Examples. However, the present invention is not limited to the following Examples. The drugs used in the following Examples and Comparative Examples were dried and refined before use by using known methods.

In the Examples and Comparative Examples below, the following measurement devices were used for polymer analysis, and the following methods were used to evaluate polymers as a lubricating oil additive.

### (1) Measurement of the Number Average Molecular Weight (Mn), Weight Average Molecular Weight (Mw), and Molecular Weight Distribution (Mw/Mn) by Gel Permeation Chromatography (GPC)

GPC device: HLC-8320, produced by Tosoh Corporation
Detector: differential refractive index detector
Column: two TSKgel SuperMultipore HZM-M columns and a SuperHZ4000 column produced by Tosoh Corporation were connected in series
Eluent: tetrahydrofuran
Eluent flow rate: 0.35 ml/min
Column temperature: 40° C.
Calibration curve: prepared using data of ten standard polystyrenes

### (2) Measurement of Monomer Conversion by Gas Chromatography (GC)

Device: Gas chromatograph GC-14A produced by Shimadzu Corporation
Detector: hydrogen flame ionization detector (FID)
Carrier gas: helium
Split ratio: 30.0
Flow rates: total flow rate: 78.9 mL/min, column flow rate: 2.54 mL/min, linear velocity: 37.0/sec, purge flow rate: 0.3 mL/min
Column: InertCap 1 produced by GL Sciences (df=0.4 μm, 0.25 mm (inner diameter)×60 m (length))
Analysis conditions: 240° C. (injection), 300° C. (detector), 50° C. (maintained for 0 minute)→10° C./min→280° C. (maintained for 7 minutes)

### (3) Calculation for Triad Syndiotacticity (Rr)

The methacrylic copolymers obtained in the Examples and Comparative Examples were subjected to ¹³C-NMR measurement. The integral value (X) of the area from 44.2 to 44.8 ppm, the integral value (Y) of the area from 44.8 to 45.3 ppm, and the integral value (Z) of the area from 45.4 to 46.0 ppm, with TMS being defined as 0 ppm, were measured, and the value obtained from the following equation was considered to be the triad syndiotacticity (rr) (%):

(X/(X+Y+Z))×100.

Measurement device: Nuclear magnetic resonance apparatus (Ultrashield 400 Plus, produced by Bruker)
Measurement solvent: deuterochloroform
Measurement nuclide: ¹³C
Measurement sample: 100 mg of sample was dissolved in 0.5 mL of deuterochloroform
Cumulative number: 5120 times
Measurement temperature: room temperature

### (4) Kinematic Viscosity Measurement and Viscosity Index Calculation

The measurement and calculation were performed according to JIS K2283-1993.

### (5) Shear Viscosity Measurement

The measurement was performed according to ASTM D-4683.

### (6) Solubility Evaluation

Five parts by mass of the methacrylic copolymer and 95 parts by mass of a lubricant base oil (YUBASE 4, produced by Exxon Mobil Corporation) were mixed at 120° C. for 24 hours in a nitrogen atmosphere to thus prepare a lubricating oil composition. The methacrylic copolymer-containing lubricating oil composition was allowed to stand at 80° C. for 1 hour or at 0° C. for 24 hours, and then visually observed to confirm the presence or absence of insoluble residues. The composition without insoluble residue was evaluated as “o” and the composition with insoluble residue was evaluated as “x”.

### (7) Calculation of Shear Viscosity Reduction Rate

As the index of shear stability, the shear viscosity reduction rate was calculated according to JPI-5S-29.

### Production Example 1A

A thoroughly dried 1-L three-necked flask was equipped with a three-way cock, and purged with nitrogen. Thereafter, 10 g of a toluene solution comprising 623 g of toluene, 16 g of 1,2-dimethoxyethane, and 0.45 M of isobutylbis(2,6-di-t-butyl-4-methylphenoxy)aluminum was added thereto at room temperature, followed by further addition of 0.4 g of a mixed solution of cyclohexane and n-hexane, containing 0.48 mmol of sec-butyl lithium. Subsequently, 110 g of a mixture comprising 30 mass % of methyl methacrylate, 30 mass % of stearyl methacrylate, and 40 mass % of lauryl methacrylate, which are alkyl methacrylate ester monomers, was added thereto as a starting material, followed by stirring at 20° C. for 12 hours. The reaction solution had a yellow color at the beginning but became colorless after 12-hour stirring. At this time, 0.5 g of the reaction solution was collected for analysis in a sampling container containing a small amount of methanol. The results of GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. Then, 25.7 g of 30% aqueous acetic acid was added at room temperature to the obtained solution to stop the polymerization. The solution was heated at 95° C. for 2 hours, and metal salts were deposited. After the resulting solution was allowed to stand overnight, the supernatant was collected, and a toluene solution containing the methacrylic copolymer at a concentration of 15 mass % was obtained. The obtained reaction solution was introduced into a beaker containing 5000 mL of methanol, and a deposit was obtained. The deposit was vacuum dried at 80° C. for 24 hours, thus obtaining 110 g of polymer in a rice cake form. The results of GPC measurement of the obtained methacrylic copolymer indicated that the weight average molecular weight (Mw) was 298,000, the number average molecular weight (Mn) was 244,300, and the molecular weight distribution (Mw/Mn) was 1.22. The results of the ¹³C-NMR measurement of the copolymer indicated that the triad syndiotacticity (rr) was 75%.

### Production Example 2A

The reaction was carried out as in Production Example 1A, except that the starting material was changed to a mixture comprising 31 mass % of methyl methacrylate, 30 mass % of stearyl methacrylate, and 39 mass % of lauryl methacrylate, which are alkyl methacrylate ester monomers. The results of GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of GPC measurement of the obtained methacrylic copolymer indicated that the weight average molecular weight (Mw) was 295,000, the number average molecular weight (Mn) was 245,800, and the molecular weight distribution (Mw/Mn) was 1.20. The results of the ¹³C-NMR measurement of the copolymer indicated that the triad syndiotacticity (rr) was 75%.

### Production Example 3A

The reaction was carried out as in Production Example 1A, except that the starting material was changed to a mixture comprising 32 mass % of methyl methacrylate, 30 mass % of stearyl methacrylate, and 38 mass % of lauryl methacrylate, which are alkyl methacrylate ester monomers. The results of GC measurement of this reaction solution indicated that the conversion of the stearyl methacrylate as an alkyl methacrylate ester monomer was 100′, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 298,000, the number average molecular weight (Mn) was 244,300, and the molecular weight distribution (Mw/Mn) was 1.22. The results of the ¹³C-NMR measurement of the copolymer indicated that the triad syndiotacticity (rr) was 75%.

### Production Example 4A

The reaction was carried out as in Production Example 1A, except that the starting material was changed to a mixture comprising 34 mass % of methyl methacrylate, 32 mass % of stearyl methacrylate, and 34 mass % of lauryl methacrylate, which are alkyl methacrylate ester monomers. The results of GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 295,000, the number average molecular weight (Mn) was 243,800, and the molecular weight distribution (Mw/Mn) was 1.21. The results of the ¹³C-NMR measurement of the copolymer indicated that the triad syndiotacticity (rr) was 75%.

### Production Example 5A

The reaction was carried out as in Production Example 1A, except that the starting material was changed to a mixture comprising 34 mass % of methyl methacrylate, 31 mass % of stearyl methacrylate, and 35 mass % of lauryl methacrylate, which are alkyl methacrylate ester monomers. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 292,000, the number average molecular weight (Mn) was 237,400, and the molecular weight distribution (Mw/Mn) was 1.23. The results of the ¹³C-NMR measurement of the copolymer indicated that the triad syndiotacticity (rr) was 75%.

### Production Example 6A

The reaction was carried out as in Production Example 1A, except that the starting material was changed to a mixture comprising 40 mass % of methyl methacrylate, 32 mass % of stearyl methacrylate, and 28 mass % of lauryl methacrylate, which are alkyl methacrylate ester monomers. The results of GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 290,000, the number average molecular weight (Mn) was 237,700, and the molecular weight distribution (Mw/Mn) was 1.22. The results of the ¹³C-NMR measurement of the copolymer indicated that the triad syndiotacticity (rr) was 75%.

### Production Example 7A

The reaction was carried out as in Production Example 1A, except that the starting material was changed to a mixture comprising 37 mass % of methyl methacrylate, 32 mass % of stearyl methacrylate, and 31 mass % of lauryl methacrylate, which are alkyl methacrylate ester monomers. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 296,000, the number average molecular weight (Mn) was 246,700, and the molecular weight distribution (Mw/Mn) was 1.20. The results of the ¹³C-NMR measurement of the copolymer indicated that the triad syndiotacticity (rr) was 75%.

### Production Example 8A

The reaction was carried out as in Production Example 1A, except that the starting material was changed to a mixture comprising 37 mass % of methyl methacrylate, 28 mass % of stearyl methacrylate, and 35 mass % of lauryl methacrylate, which are alkyl methacrylate ester monomers. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 296,000, the number average molecular weight (Mn) was 242,600, and the molecular weight distribution (Mw/Mn) was 1.22. The results of the ¹³C-NMR measurement of the copolymer indicated that the triad syndiotacticity (rr) was 75%.

### Production Example 9A

The reaction was carried out as in Production Example 1A, except that the starting material was changed to a mixture comprising 37 mass % of methyl methacrylate, 35 mass % of stearyl methacrylate, and 28 mass % of lauryl methacrylate, which are alkyl methacrylate ester monomers. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 296,000, the number average molecular weight (Mn) was 242,600, and the molecular weight distribution (Mw/Mn) was 1.22. The results of the i-C-NMR measurement of the copolymer indicated that the triad syndiotacticity (rr) was 75%.

### Example 1A

Fifteen mass % of the methacrylic copolymer (C) obtained in Production Example 1A and 85 mass % of toluene were mixed at 80° C. for 24 hours in a nitrogen atmosphere to prepare a toluene solution. To this solution, a commercially available lubricant base oil (YUBASE 4, produced by SK lubricants Japan Co., Ltd., API group III, viscosity index: 122) was added for dilution in an amount of 85 mass %, relative to the methacrylic copolymer. The methacrylic copolymer solution after dilution was subjected to toluene devolatilization using a rotating evaporator at 80° C. at 1 torr for 2 hours. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Table 1 shows the results.

### Example 2A

The reaction was carried out as in Example 1A, except that the methacrylic copolymer (C) obtained in Production Example 2A was used. The results of GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Table 1 shows the results.

### Example 3A

The reaction was carried out as in Example 1A, except that the methacrylic copolymer (C) obtained in Production Example 3A was used. The results of GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Table 1 shows the results.

### Example 4A

The reaction was carried out as in Example 1A, except that the methacrylic copolymer (C) obtained in Production Example 4A was used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Table 1 shows the results.

### Example 5A

The reaction was carried out as in Example 1A, except that the methacrylic copolymer (C) obtained in Production Example 5A was used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Table 1 shows the results.

### Example 6A

The reaction was carried out as in Example 1A, except that the methacrylic copolymer (C) obtained in Production Example 2A was used, and that 95% of the base oil and 5% of the resin were used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Additionally, the thixotropy (TI value) was measured. Table 1 shows the results.

### Comparative Example 1A

The reaction was carried out as in Example 1A, except that the methacrylic copolymer (C) obtained in Production Example 6A was used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, deposit was observed. When the solution was visually observed after being allowed to stand at 0° C. for 24 hours, deposit was observed. Table 1 shows the results.

### Comparative Example 2A

The reaction was carried out as in Example 1A, except that the methacrylic copolymer (C) obtained in Production Example 7A was used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, deposit was observed. When the solution was visually observed after being allowed to stand at 0° C. for 24 hours, deposit was observed. Table 1 shows the results.

### Comparative Example 3A

The reaction was carried out as in Example 1A, except that the methacrylic copolymer (C) obtained in Production Example 8A was used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, deposit was observed. When the solution was visually observed after being allowed to stand at 0° C. for 24 hours, deposit was observed. Table 1 shows the results.

### Comparative Example 4A

The reaction was carried out as in Example 1A, except that the methacrylic copolymer (C) obtained in Production Example 9A was used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, deposit was observed. Table 1 shows the results.

### Reference Example 1A

Fifteen mass % of the methacrylic copolymer (C) obtained in Production Example 5A and 85 mass % of toluene were mixed at 80° C. for 24 hours in a nitrogen atmosphere to prepare a toluene solution. To this solution, a commercially available lubricant base oil (YUBASE 2, produced by SK lubricants Japan Co., Ltd., API group II, viscosity index: 100) was added for dilution in an amount of 85 mass %, relative to the methacrylic copolymer. The methacrylic copolymer solution after dilution was subjected to toluene devolatilization using a rotating evaporator at 80° C. at 1 torr for 2 hours. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Table 1 shows the results.

### Reference Example 2A

The reaction was carried out as in Reference Example 1A, except that the methacrylic copolymer (C) obtained in Production Example 9A was used. The results of the GC measurement of the methacrylic copolymer solution after devolatilization indicated that the amount of toluene contained in the lubricant base oil solution was 0.1 mass %. When the solution was visually observed after being allowed to stand at 80° C. for 1 hour, no deposit was observed. When the solution was visually observed after being allowed to stand at 0° C. for 24 hours, no deposit was observed. Here, the methacrylic copolymer obtained in Production Example 9A was used in the same manner as in Comparative Example 4. Although deposit was observed in the API group III lubricant base oil having a high viscosity index in Comparative Example 4, no deposit was observed here in Reference Example 2A since an API group III lubricant base oil having a low viscosity index was used. Table 1 shows the results.

### Reference Example 3A

The methacrylic copolymer (C) was not used while 100% of a base oil was used, and the TI was measured. Table 1 shows the results.

TABLE 1

| | | | | | | | | Production |
|---|---|---|---|---|---|---|---|---|
| | | | Production | Production | Production | Production | Production | Example |
| | | | Example | Example | Example | Example | Example | 6A |
| | | | 1A | 2A | 3A | 4A | 5A | Comp. |
| | | | Example | Example | Example | Example | Example | Example |
| | | | 1A | 2A | 3A | 4A | 5A | 1A |
| Resin used | Methyl methacrylate | mass % | 30 | 31 | 32 | 34 | 34 | 40 |
| | n-Stearyl methacrylate | mass % | 30 | 30 | 30 | 32 | 31 | 32 |
| | n-Lauryl methacrylate | mass % | 40 | 39 | 38 | 34 | 35 | 28 |
| | Molecular weight | Mw | 298000 | 295000 | 298000 | 295000 | 292000 | 290000 |
| | Molecular weight | Mn | 244300 | 245800 | 244300 | 243800 | 237400 | 237700 |
| | Molecular weight distribution | Mw/Mn | 1.22 | 1.20 | 1.22 | 1.21 | 1.23 | 1.22 |
| | Triad syndiotacticity | % | 75 | 75 | 75 | 75 | 75 | 75 |
| Formulation | Base oil (YUBASE 4, VI = 122) | mass % | 85.0 | 85.0 | 85.0 | 85.0 | 85.0 | 85.0 |
| | Base oil (YUBASE 2, VI = 100) | mass % | 0.0 | 0.0 | 0.0 | 0.0 | 0.0 | 0.0 |
| | Resin | mass % | 15.0 | 15.0 | 15.0 | 15.0 | 15.0 | 15.0 |
| Solubility | After being allowed to stand | Visual | ◯ | ◯ | ◯ | ◯ | ◯ | X |
| | at 80° C. for 1 hour | observation | | | | | | |
| | After being allowed to stand | Visual | ◯ | ◯ | ◯ | ◯ | ◯ | X |
| | at 0° C. for 24 hours | observation | | | | | | |
| | Resin composition in total | mass % | 100.0 | 100.0 | 100.0 | 100.0 | 100.0 | 100.0 |
| | Formulation in total | mass % | 100.0 | 100.0 | 100.0 | 100.0 | 100.0 | 100.0 |

| | | | Production | Production | Production | Production | Production |
|---|---|---|---|---|---|---|---|
| | | | Example | Example | Example | Example | Example |
| | | | 7A | 8A | 9A | 5A | 9A |
| | | | Comp. | Comp. | Comp. | Reference | Reference |
| | | | Example | Example | Example | Example | Example |
| | | | 2A | 3A | 4A | 1A | 2A |
| Resin used | Methyl methacrylate | mass % | 37 | 37 | 37 | 34 | 37 |
| | n-Stearyl methacrylate | mass % | 32 | 28 | 35 | 31 | 35 |
| | n-Lauryl methacrylate | mass % | 31 | 35 | 28 | 35 | 28 |
| | Molecular weight | Mw | 296000 | 296000 | 296000 | 292000 | 296000 |
| | Molecular weight | Mn | 246700 | 242600 | 242600 | 237400 | 242600 |
| | Molecular weight distribution | Mw/Mn | 1.20 | 1.22 | 1.22 | 1.23 | 1.22 |
| | Triad syndiotacticity | % | 75 | 75 | 75 | 75 | 75 |
| Formulation | Base oil (YUBASE 4, VI = 122) | mass % | 85.0 | 85.0 | 85.0 | | |
| | Base oil (YUBASE 2, VI = 100) | mass % | 0.0 | 0.0 | 0.0 | 85.0 | 85.0 |
| | Resin | mass % | 15.0 | 15.0 | 15.0 | 15.0 | 15.0 |
| Solubility | After being allowed to stand | Visual | X | X | ◯ | ◯ | ◯ |
| | at 80° C. for 1 hour | observation | | | | | |
| | After being allowed to stand | Visual | X | X | X | ◯ | ◯ |
| | at 0° C. for 24 hours | observation | | | | | |
| | Resin composition in total | mass % | 100.0 | 100.0 | 100.0 | 100.0 | 100.0 |
| | Formulation in total | mass % | 100.0 | 100.0 | 100.0 | 100.0 | 100.0 |

| | | | Production | Production |
|---|---|---|---|---|
| | | | Example 2A | Reference |
| | | | Example 6A | Example 3A |
| Resin used | Methyl methacrylate | mass % | 31 | — |
| | n-Stearyl methacrylate | mass % | 30 | — |
| | n-Lauryl methacrylate | mass % | 39 | — |
| | Molecular weight | Mw | 295000 | — |
| | Molecular weight | Mn | 245800 | — |
| | Molecular weight distribution | Mw/Mn | 1.20 | — |
| | Triad syndiotacticity | % | 75 | |
| Formulation | Base oil (YUBASE4, VI = 122) | mass % | 95.0 | 100 |
| | Base oil (YUBASE2, VI = 100) | mass % | 0.0 | 0 |
| | Resin | mass % | 5.0 | 0 |
| Solubility | After being allowed to stand at 80° C. for 1 | Visual observation | ◯ | — |
| | hour | | | |
| | After being allowed to stand at 0° C. for 24 | Visual observation | ◯ | — |
| | hours | | | |
| Thixotropy | TI value | | 1.3 | 1.0 |

“X”

### Production Example 18B

A thoroughly dried 1-L three-necked flask was equipped with a three-way cock, and purged with nitrogen. Thereafter, 11 g of a toluene solution comprising 453 g of toluene, 9 g of 1,2-dimethoxyethane, and 0.45 M of isobutylbis(2,6-di-t-butyl-4-methylphenoxy)aluminum was added thereto at room temperature, followed by further addition of 1.8 g of a mixed solution of cyclohexane and n-hexane, containing 2.8 mol of sec-butyl lithium. Subsequently, 80 g of a mixture comprising 30 mass % of methyl methacrylate, 30 mass % of stearyl methacrylate, and 40 mass % of lauryl methacrylate, which are alkyl methacrylate ester monomers, was added thereto as a starting material, followed by stirring at 15° C. for 12 hours. The reaction solution had a yellow color at the beginning but became colorless after 12-hour stirring. At this time, 0.5 g of the reaction solution was collected for analysis in a sampling container containing a small amount of methanol. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. Then, 17.9 g of 30% aqueous acetic acid was added at room temperature to the obtained solution to stop the polymerization. The solution was heated at 95° C. for 2 hours, and metal salts were deposited. After the resulting solution was allowed to stand overnight, the supernatant was collected, and a toluene solution containing the methacrylic copolymer at a concentration of 15 mass % was obtained. The obtained reaction solution was introduced into a beaker containing 5000 mL of methanol, and a deposit was obtained. The deposit was vacuum dried at 80° C. for 24 hours, thus obtaining 80 g of polymer in a rice cake form. The results of the GPC measurement of the obtained methacrylic copolymer indicated that the weight average molecular weight (Mw) was 30,000, the number average molecular weight (Mn) was 28,600, and the molecular weight distribution (Mw/Mn) was 1.05. The results of the ¹³C-NMR measurement of the copolymer indicated that the triad syndiotacticity (rr) was 80%.

### Production Example 2B

The reaction was carried out as in Production Example 1B, except that 0.56 g of a mixed solution of cyclohexane and n-hexane, containing 0.87 mmol of sec-butyl lithium was added. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 100,000, the number average molecular weight (Mn) was 91,700, and the molecular weight distribution (Mw/Mn) was 1.09. The results of the ¹³C-NMR measurement of the copolymer indicated that the triad syndiotacticity (rr) was 80%.

### Production Example 3B

The reaction was carried out as in Production Example 1B, except that 0.29 g of a mixed solution of cyclohexane and n-hexane, containing 0.46 mmol of sec-butyl lithium was added. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 200,000, the number average molecular weight (Mn) was 173,900, and the molecular weight distribution (Mw/Mn) was 1.15. The results of the ¹³C-NMR measurement of the copolymer indicated that the triad syndiotacticity (rr) was 80%.

### Production Example 4B

The reaction was carried out as in Production Example 1B, except that 0.21 g of a mixed solution of cyclohexane and n-hexane, containing 0.33 mmol of sec-butyl lithium was added. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 300,000, the number average molecular weight (Mn) was 243,900, and the molecular weight distribution (Mw/Mn) was 1.23. The results of the ¹³C-NMR measurement of the copolymer indicated that the triad syndiotacticity (rr) was 80%.

### Production Example 5B

The reaction was carried out as in Production Example 1B, except that 0.17 g of a mixed solution of cyclohexane and n-hexane, containing 0.27 mmol of sec-butyl lithium was added. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 400,000, the number average molecular weight (Mn) was 294,100, and the molecular weight distribution (Mw/Mn) was 1.36. The results of the ¹³C-NMP measurement of the copolymer indicated that the triad syndiotacticity (rr) was 80%.

### Production Example 6B

The reaction was carried out as in Production Example 1B, except that the reaction was carried out at 55° C. The results of the GC measurement of the obtained reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 30,000, the number average molecular weight (Mn) was 28,600, and the molecular weight distribution (Mw/Mn) was 1.05. The results of the ¹³C-NMR measurement of the copolymer indicated that the triad syndiotacticity (rr) was 60%.

### Production Example 7B

A 300-mL three-necked glass flask reactor was equipped with a three-way cock, and purged with nitrogen. Thereafter, 87.0 g of toluene, 26.1 g of methyl methacrylate, 26.1 g of stearyl methacrylate, 34.8 g of lauryl methacrylate, 0.183 g (1.11 mmol) of 2,2′-azobis(isobutyronitrile), and 0.345 g (1.71 mmol) of 1-dodecanethiol were added thereto at room temperature. Subsequently, the reaction solution in the reactor was subjected to nitrogen bubbling for 30 minutes, followed by stirring at 50° C. for 24 hours to perform polymerization. At this time, 0.5 g of the reaction solution was collected for analysis in a sampling container containing a small amount of methanol. The results of the GC measurement of this reaction solution indicated that the conversion of the stearyl methacrylate as an alkyl methacrylate ester monomer was 57%, the conversion of the lauryl methacrylate as an alkyl methacrylate ester monomer was 57%, and the conversion of the methyl methacrylate as an alkyl methacrylate ester monomer was 57%. After the reaction solution was cooled to 25° C., a toluene solution containing the methacrylic copolymer at a concentration of 28.5 mass % was obtained. The obtained reaction solution was introduced into a beaker containing 5000 mL of methanol, and a deposit was obtained. The deposit was vacuum dried at 110° C. for 24 hours, thus obtaining 87 g of polymer in a rice cake form. The results of the GPC measurement of the obtained methacrylic copolymer indicated that the weight average molecular weight (Mw) was 400,000, the number average molecular weight (Mn) was 186,000, and the molecular weight distribution (Mw/Mn) was 2.15. The results of the ¹³C-NMR measurement of the copolymer indicated that the triad syndiotacticity (rr) was 80%.

### Production Example 8B

The reaction was carried out as in Production Example 1B, except that 0.12 g of a mixed solution of cyclohexane and n-hexane, containing 0.19 mmol of sec-butyl lithium was added. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 600,000, the number average molecular weight (Mn) was 431,700, and the molecular weight distribution (Mw/Mn) was 1.39. The results of the ¹³C-NMR measurement of the copolymer indicated that the triad syndiotacticity (rr) was 80%.

### Production Example 9B

The reaction was carried out as in Production Example 1B, except that the starting material was changed to 80 g of a mixture comprising 60 mass % of methyl methacrylate, 20 mass % of stearyl methacrylate, and 20 mass % of lauryl methacrylate, which are alkyl methacrylate ester monomers. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%, and the conversion of the methyl methacrylate as an alkyl methacrylate ester monomer was 100%. The results of the GPC measurement of the obtained methacrylic copolymer indicated that the weight average molecular weight (Mw) was 30,000, the number average molecular weight (Mn) was 28,600, and the molecular weight distribution (Mw/Mn) was 1.05. The results of the ¹³C-NMR measurement of the copolymer indicated that the triad syndiotacticity (rr) was 80%.

### Production Example 10B

The reaction was carried out as in Production Example 1B, except that the starting material was changed to 80 g of a mixture comprising 50 mass % of stearyl methacrylate and 50 mass % of lauryl methacrylate, which are alkyl methacrylate ester monomers. The results of the GC measurement of this reaction solution indicated that the conversion of the stearyl methacrylate as an alkyl methacrylate ester monomer was 100%, the conversion of the lauryl methacrylate as an alkyl methacrylate ester monomer was 100%. The results of the GPC measurement of the obtained methacrylic copolymer indicated that the weight average molecular weight (Mw) was 30,000, the number average molecular weight (Mn) was 28,600, and the molecular weight distribution (Mw/Mn) was 1.05. The results of the ¹³C-NMR measurement of the copolymer indicated that the triad syndiotacticity (rr) was 80%.

### Example 1B

A lubricating oil composition was prepared by mixing 2.5 g of the resin obtained in Production Example 1B and 47.5 g of mineral oil (YUBASE 4), and the solution was visually observed after being allowed to stand at 80° C. for 1 hour and after being allowed to stand at 0° C. for 24 hours. Further, the kinematic viscosity was measured, and the viscosity index was calculated. Additionally, the shear viscosity was measured, and the shear viscosity reduction rate was calculated. Table 2 shows the results.

### Examples 2B to 5B and Comparative Examples 1B to 5B

The reaction was carried out as in Example 1B, except that the resins obtained in Production Examples 2B to 10B were used. Table 2 shows the results.

TABLE 2

| | | | Example 1B | Example 2B | Example 3B | Example 4B | Example 5B |
|---|---|---|---|---|---|---|---|
| | | | Production | Production | Production | Production | Production |
| | | | Example 1B | Example 2B | Example 3B | Example 4B | Example 5B |
| Methacrylic | Methyl methacrylate | mass % | 30 | 30 | 30 | 30 | 30 |
| copolymer | n-Stearyl methacrylate | mass % | 30 | 30 | 30 | 30 | 30 |
| | n-Lauryl methacrylate | mass % | 40 | 40 | 40 | 40 | 40 |
| | Weight average molecular | | 30000 | 100000 | 200000 | 300000 | 400000 |
| | weight (Mw) | | | | | | |
| | Number average molecular | | 28600 | 91700 | 173900 | 243900 | 294100 |
| | weight (Mn) | | | | | | |
| | Molecular weight | | 1.05 | 1.09 | 1.15 | 1.23 | 1.36 |
| | distribution (Mw/Mn) | | | | | | |
| | Triad syndiotacticity | % | 80 | 80 | 80 | 80 | 80 |
| Formulation | Lubricant base oil (YUBASE 4) | mass % | 95 | 95 | 95 | 95 | 95 |
| | Methacrylic copolymer | mass % | 5 | 5 | 5 | 5 | 5 |
| Solubility | Kinematic viscosity (40° C.) | mm²/s | 58.7 | 78.2 | 101.5 | 181.2 | 226.3 |
| | Kinematic viscosity (100° C.) | mm²/s | 11.7 | 15.5 | 22.3 | 37.6 | 48.5 |
| | Viscosity index | — | 199 | 211 | 249 | 257 | 268 |
| | Shear viscosity index | % | 1.5 | 2.3 | 3.9 | 4.5 | 5.9 |
| | After being allowed to stand | Visual | ◯ | ◯ | ◯ | ◯ | ◯ |
| | at 80° C. for 1 hour | observation | | | | | |
| | After being allowed to stand | Visual | ◯ | ◯ | ◯ | ◯ | ◯ |
| | at 0° C. tor 24 hours | observation | | | | | |
| | | | | | | | Comp. |
| | | | Comp. | Comp. | Comp. | Comp. | Example 5B |
| | | | Example 1B | Example 2B | Example 3B | Example 4B | Production |
| | | | Production | Production | Production | Production | Example |
| | | | Example 6B | Example 7B | Example 8B | Example 9B | 10B |
| Methacrylic | Methyl methacrylate | mass % | 30 | 30 | 30 | 60 | 0 |
| copolymer | n-Stearyl methacrylate | mass % | 30 | 30 | 30 | 20 | 50 |
| | n-Lauryl methacrylate | mass % | 40 | 40 | 40 | 20 | 50 |
| | Weight average molecular | | 300000 | 400000 | 600000 | 30000 | 30000 |
| | weight (Mw) | | | | | | |
| | Number average molecular | | 28600 | 186000 | 431700 | 28600 | 28600 |
| | weight (Mn) | | | | | | |
| | Molecular weight | | 1.05 | 2.15 | 1.39 | 1.05 | 1.05 |
| | distribution (Mw/Mn) | | | | | | |
| | Triad syndiotacticity | % | 60 | 80 | 80 | 80 | 80 |
| Formulation | Lubricant base oil (YUBASE 4) | mass % | 95 | 95 | 95 | 95 | 95 |
| | Methacrylic copolymer | mass % | 5 | 5 | 5 | 5 | 5 |
| Solubility | Kinematic viscosity (40° C.) | mm²/s | 60.9 | 220.2 | 230.1 | Immeasurable | 63.5 |
| | Kinematic viscosity (100° C.) | mm²/s | 11.5 | 43.2 | 50.5 | Immeasurable | 11.5 |
| | Viscosity index | — | 187 | 252 | 278 | Incalculable | 178 |
| | Shear viscosity index | % | 1.5 | 24.5 | 10.1 | Incalculable | 1.9 |
| | After being allowed to stand | Visual | ◯ | ◯ | ◯ | X | ◯ |
| | at 80° C. for 1 hour | observation | | | | | |
| | After being allowed to stand | Visual | ◯ | ◯ | ◯ | X | ◯ |
| | at 0° C. tor 24 hours | observation | | | | | |

### INDUSTRIAL APPLICABILITY

The methacrylic copolymer of the present invention is suitably used as a viscosity index improver for engine oils (e.g., for gasoline and for diesel), drive system oils (gear oils (e.g., manual transmission oil, and differential oil), automatic transmission oils (ATF (automatic transmission fluid), CVTF (continuously variable transmission fluid))), hydraulic oils (power-steering oil, shock absorber oil), and the like.

Further, the methacrylic copolymer of the present invention can be used in various applications, including viscosity modifiers for paint or ink, polyolefin modifiers, pressure-sensitive adhesives, adhesives, primers, surface-functionalization coating agents, such as hard coats, tire modifiers, and the like.

1: A methacrylic copolymer (C) comprising:
25 to 35 mass % of a methyl methacrylate unit (A); and
75 to 65 mass % of an alkyl methacrylate ester unit (B) containing an alkyl group having 10 to 36 carbon atoms,
the methacrylic copolymer having
(a) a weight average molecular weight of 10,000 to 500,000,
(b) a molecular weight distribution (Mw/Mn) of 1.01 to 1.60,
(c) a triad syndiotacticity (rr) of 65% or more, and
(d) a solubility of 5.0 mass % or more at 0° C. in at least one lubricant base oil (D) selected from the group consisting of API groups III, III+, and IV.

2: The methacrylic copolymer according to claim 1, wherein the methyl methacrylate unit (A) is present in an amount of 30 to 35 mass %.

3: The methacrylic copolymer according to claim 1, which has a weight average molecular weight of 20,000 to 450,000.

4: The methacrylic copolymer according to claim 1, comprising a combination of an alkyl methacrylate ester unit (B1) containing an alkyl group having 14 to 30 carbon atoms and an alkyl methacrylate ester unit (B2) containing an alkyl group having 10 to 13 carbon atoms, as the alkyl methacrylate ester unit (B) containing an alkyl group having 10 to 36 carbon atoms, and having a mass ratio of the alkyl methacrylate ester unit (B1)/the alkyl methacrylate ester unit (B2) of 10/90 to 90/10.

5: The methacrylic copolymer according to claim 1, which has a molecular weight distribution (Mw/Mn) of 1.01 to 1.40.

6: A method for producing the methacrylic copolymer of claim 1, comprising
anionically polymerizing a monomer mixture comprising methyl methacrylate and an alkyl methacrylate ester containing an alkyl group having 10 to 36 carbon atoms in the presence of an organic aluminum compound.

7: A methacrylic copolymer solution comprising the methacrylic copolymer of claim 1 and an organic solvent.

8: The methacrylic copolymer solution according to claim 7, wherein the organic solvent is at least one lubricant base oil selected from the group consisting of API groups III, III+, and IV.

9: The methacrylic copolymer solution according to claim 7, wherein the organic solvent is an organic solvent for paint.

10: The methacrylic copolymer solution according to claim 7, wherein the organic solvent is an organic solvent for ink.

11: A lubricating oil composition comprising the methacrylic copolymer of claim 1 and at least one lubricant base oil (D) selected from the group consisting of API groups III, III+, and IV.

12: The lubricating oil composition according to claim 11, wherein the methacrylic copolymer is present in an amount of 10 to 50 mass %.

13: The lubricating oil composition according to claim 11, wherein the lubricant base oil (D) is a mineral oil or poly-α-olefin synthetic oil.

14: A viscosity index improver comprising the methacrylic copolymer of claim 1.
